(19) United States
(12) Patent Application Publication
(10) Pub. No.: US 2010/0213218 A1
(43) Pub. Date: Aug. 26, 2010

(54) DISPENSING SYSTEM AND METHOD OF USE

(76) Inventor: Matthew H. Johnson, Eagan, MN (US)

Correspondence Address: Matthew H. Johnson, 3605 Blue Jay Way, Eagan, MN, 55123, US

(21) Appl. No.: 12/705,575

(22) Filed: Feb. 13, 2010

Related U.S. Application Data
(60) Provisional application No. 61/207,732, filed on Feb. 13, 2009.

(51) Int. Cl. G01F 11/10

(52) U.S. Cl. 222/361; 222/282; 222/305

(57) ABSTRACT

A dispensing system comprising a housing having an inlet opening and a channel, and a slide mechanism configured to extend through the channel, where the slide mechanism comprises a first end configured to extend out of a first opening of the channel, a second end that having at least one stop component and being configured to extend out of the second opening of the channel, and a plurality of volume chambers configured to be at least partially accessible to the inlet opening of the housing.

### CROSS-REFERENCE TO RELATED APPLICATION(S)

The present application claims priority to U.S. Provisional Application No. 61/207,732, filed on Feb. 13, 2009, and entitled “Bottomless Drawer, Variable Measuring, Dry Flowable Material Quick Pull Dispenser”, the disclosure of which is incorporated by reference in its entirety.

### BACKGROUND

The present disclosure relates to dispensing systems. In particular, the present disclosure relates to systems for measuring and dispensing particulate materials, such as food based grains, powders and the like.

For years people have struggled measuring spices, flour and sugars from their storage containers using measuring spoons and cups. Common problems are contamination and cross contamination that may occur when a person digs a spoon or cup into a sugar or spice container and something falls from their hand into the container such as a hair or dead skin cells or when the same spoon or cup is used with different spice containers and not properly washed in between.

Another problem with current measuring practices is that it takes a lot of time to scoop and properly level a spoon or cup and in some restaurants it takes time just to locate the spoon or cup or wait for another employee to be done using it. As such, there is an ongoing need for systems and methods for dispensing particulate materials.

### SUMMARY

An aspect of the present disclosure is directed to a dispensing system that includes a housing configured to engage with a storage container, and a slide mechanism. The housing includes an inlet opening configured to receive particulate materials from the storage container, and a channel extending through the housing and having opposing openings, the channel being accessible to the inlet opening at a location between the opposing ends. The slide mechanism includes a first end configured to extend out of a first opening of the channel, and a second end having at least one stop component, and being configured to extend out of the second opening of the channel. The slide mechanism also includes a plurality of volume chambers extending through the slide mechanism between the first end and the second end, and configured to be at least partially accessible to the inlet opening of the housing.

Another aspect of the disclosure is directed to a dispensing system that includes a housing and a slide mechanism. The housing includes an inlet opening configured to engage with a storage container, and a channel extending through the housing and having opposing openings, where the channel is accessible to the inlet opening at a location between the opposing ends. The slide mechanism includes a first end configured to extend out of a first opening of the channel and further configured to hingedly fold, and at least one stop component configured to extend out of a second opening of the channel and further configured to restrict a range of motion of the slide mechanism within the channel. The slide mechanism also includes a plurality of volume chambers extending through the slide mechanism between the first end and the at least on stop component, and configured to be at least partially accessible to the inlet opening of the housing. The slide mechanism further includes an option switch configured to further restrict the range of motion of the slide mechanism within the channel when the option switch is actuated.

A further aspect of the disclosure is directed to a method of operating a dispensing system. The method includes at least partially filling a plurality of volume chambers of a slide mechanism of the dispensing system with a material from a storage container engaged with a housing of the dispensing system, where each of the plurality of volume chambers has a different volume. The method also includes actuating an option switch of the slide mechanism, moving the slide mechanism through a channel of the housing such that at least one of the volume chambers exits the channel, restricting the movement of the slide mechanism through the channel to a range defined in part by the actuated option switch, and dispensing the material from the at least one volume chamber that exited the channel.

### BRIEF DESCRIPTION OF THE DRAWINGS

FIG. 1 is a bottom rear perspective view of a dispensing system of the present disclosure in use with a container.

FIG. 2 is a bottom front perspective view of the dispensing system in use with the container.

FIG. 3 is a top perspective view of a housing of the dispensing system.

FIG. 4 is a bottom rear perspective view of a hinged slide mechanism of the dispensing system.

### DETAILED DESCRIPTION

The present disclosure is directed to a system configured to dispense predetermined volumes of particulate materials (e.g., a one-cup dose) with the pull of a handle, and may change to smaller volumes with the flip of a switch. The system may be designed to fit larger restaurant sold spice containers, and may also be useful in other applications, such as for dispensing flour or sugar in a bakery or pizza shop. For example, the system may be used with most commercially available, spice-based containers. As such, the system effectively replaces standard spice container caps with an arrangement that measures and dispenses the spices directly from the container while compromising little space and sealing the spice container when stored. Smaller embodiments of this system may include tablespoon and/or teaspoon versions, which may change to dispense smaller volumes with the flip of a switch, and are suitable for measuring from spice containers in residential locations.

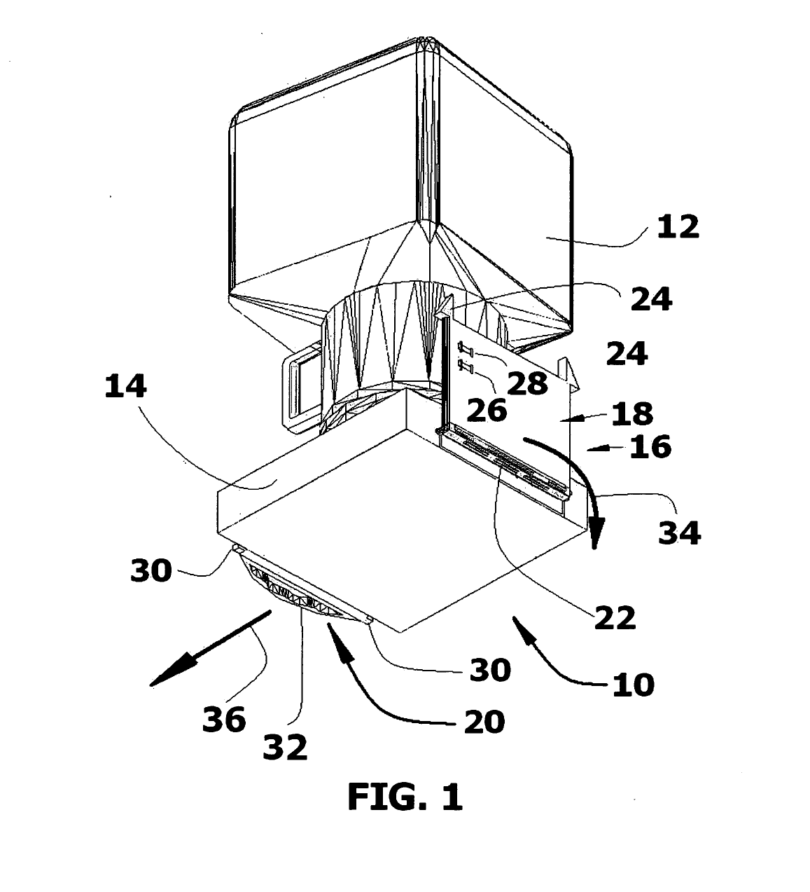

As shown in FIG. 1, system 10 is a dispensing system for measuring and dispensing materials, such as particulate matter, from storage containers, such as container 12. System 10 includes housing 14 and hinged slide mechanism 16, where hinged slide mechanism 16 is configured to extend through housing 14. Housing 14 and hinged slide mechanism 16 may each be fabricated from one or more plastic materials (e.g., thermoplastic materials) and/or metallic materials. Housing 14 is configured to engage a container, such as container 12, by attachment threads, which are engagements of the housing 14 and are configured to be engaged with reciprocating thread engagements of container 12. This allows housing 14 to be secured to container 12. As discussed below, housing 14 has a material filling opening which allows material to pass through from container 12 to hinged slide mechanism 16.

Hinged slide mechanism 16 includes rear portion 18 and front portion 20 hingedly connected with hinge 22. Rear portion 18 includes rear stoppers 24 and option switches 26 and 28, and front portion 20 includes front stoppers 30 and handle 32. This arrangement allows hinged slide mechanism 16 to glide through housing 14, when pulled or pushed by handle 32, and limits the movement of hinged slide mechanism 16 to a range between rear stoppers 24 and front stoppers 30.

As discussed below, hinged slide mechanism 16 functions as a divided measuring cup that may be filled with material from container 12 through housing 14. Rear portion 18 is shown in FIG. 1 in a folded orientation for storage. In this orientation, material from container 10 may fall into hinged slide mechanism 16, as discussed below. During use, a user may then pivot rear portion 18 downward around hinge 22, as illustrated by arrow 34, until rear portion 18 is substantially planar with front portion 20. The user may then pull handle 32 in the direction of arrow 36 to pull hinged slide mechanism 16 through housing 14, thereby allowing the material to fall by gravity through a open bottom in hinged slide mechanism 16.

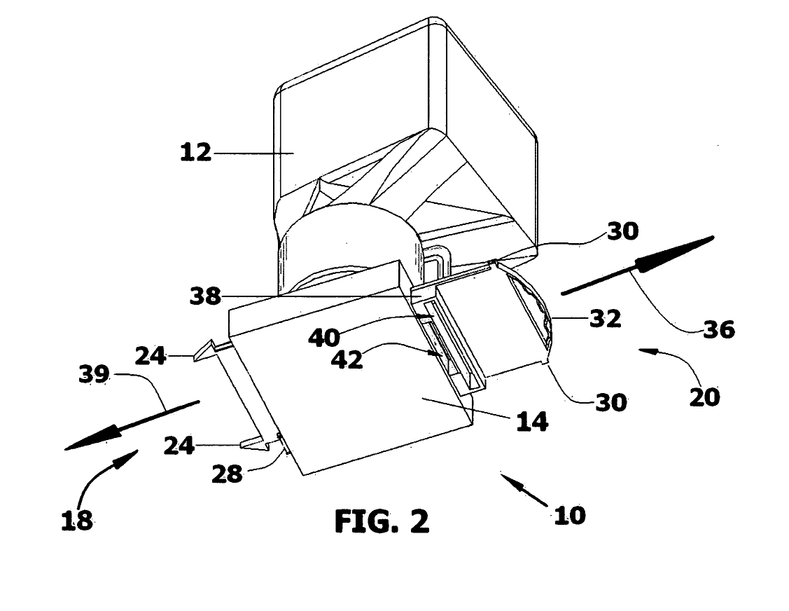

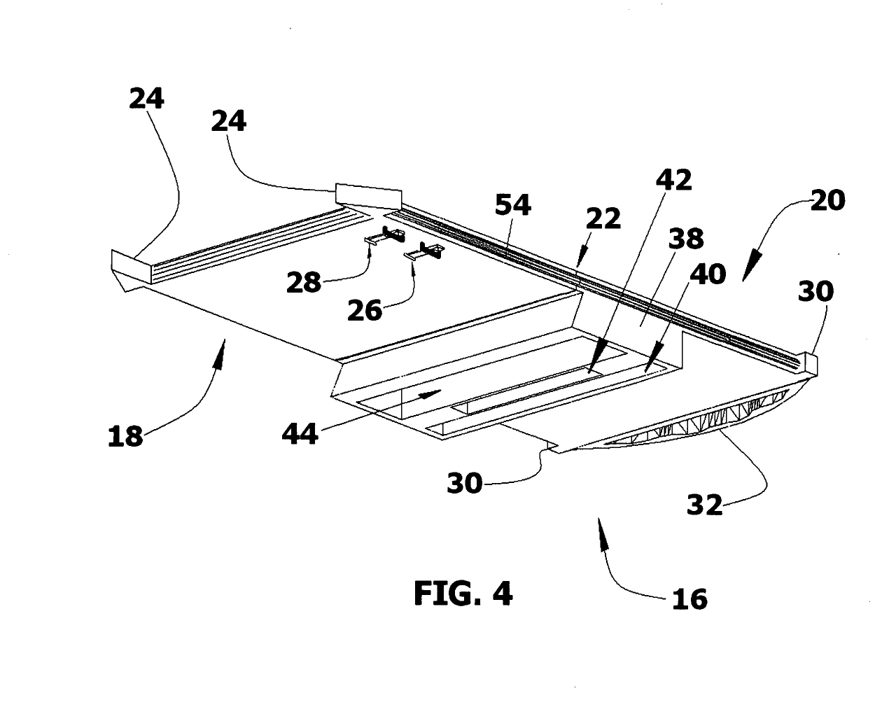

As shown in FIG. 2, when rear portion 18 is substantially planar with front portion 20, and hinged slide mechanism 16 is pulled through housing 14 in the direction of arrow 36, divided compartment 38 of front portion 20 extends out of housing 14. Divided compartment 38 is configured to transfer material from container 12, through housing 14, and into an intended destination when pulled by handle 32 in the direction of arrow 36. In the shown embodiment, divided compartment 34 includes volume chambers 40, 42, and 44 (volume chamber 44 shown in FIG. 4), which have an open top (not shown) at a top surface of hinged slide mechanism 16 (not shown) for receiving material from container 12, and bottom openings, as shown in FIG. 2, for dispensing by gravity.

As discussed below, after the material is dispensed from volume chambers 40 and 42, the user may then push hinged slide mechanism 16 back through housing 14, in the direction of arrow 38, with the use of handle 32. In the inserted state, additional amounts of the material may fall into volume chambers 40, 42, and/or 44 for additional dispensing operations.

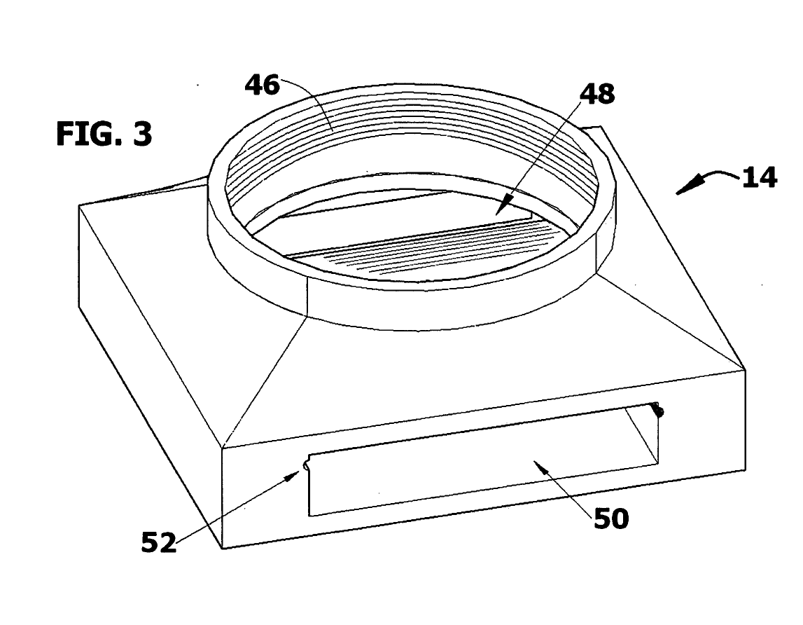

As shown in FIG. 3, housing 14 also includes attachment threads 46, material filling opening 48, slide containment channel 50, and stabilizing recess 52. Attachment threads 46 are thread engagements of housing 14, located at material filling opening 48, and are configured to be engaged with reciprocating thread engagements of container 12 (not shown). This arrangement allows housing 14 to be removably secured to container 12. In alternative embodiments, housing 14 may be removably secured to storage containers (e.g., container 12) with the use of a variety of different engagement mechanisms.

Material filling opening 48 is an opening in housing 14 through which materials may pass from storage container 12 into slide containment channel 50, and vice versa if system 10 and container 12 are flipped upside down. Slide containment channel 50 is an opening into housing 14 that surrounds and retains hinged slide mechanism 16 (shown in FIGS. 1 and 2). This allows hinged slide mechanism 16 to deliver the materials in measured quantities from material filling opening 48 through slide containment channel 50 into a desired destination.

Stabilizing recess 52 in slide containment channel 50 is a track that runs lengthwise through slide containment channel 50 and helps to stabilize hinged slide mechanism 16 when system 10 is in use. The purpose of stabilizing recess 52 is to keep a flat slide of hinged slide mechanism 16 tight against the bottom perimeter of material filling opening 48 when divided compartment 38 is being pulled from beneath material filling opening 48 for dispensing. This prevents material from falling into slide containment channel 50, outside of divided compartment 38. While shown as a rectangular opening that extends through housing 14, slide containment channel 50 may alternatively exhibit a variety of geometries to engage with hinged slide mechanisms having a variety of different reciprocating geometries.

As shown in FIG. 4, hinged slide mechanism 16 includes flat slide 54, which is configured to be received in stabilizing recess 52 of housing 14 (shown in FIG. 3), thereby providing a barrier for blocking materials from entering slide containment channel 50 below hinged slide mechanism 16.

Volume chambers 40, 42, and 44 desirably have different predetermined volumes from each other, thereby allowing different volumes of the materials to be dispensed. For example, the combined volumes of volume chambers 40, 42, and 44 may equal about one volumetric cup. Thus, if one volumetric cup of the material from storage container 12 (shown in FIG. 1) is desired, a user may pull handle 32 until rear stoppers 24 of hinged slide mechanism 16 contact housing 14, thereby extending volume chambers 40, 42, and 44 out of slide stabilizing channel 50 and dispensing the material through the open bottoms of volume chambers 40, 42, and 44 via gravity.

If multiple volumetric cups are desired, the user may push handle 32 inward until front stoppers 30 of hinged slide mechanism 16 contact housing 14, thereby preventing hinged slide mechanism 16 from moving further. This places volume chambers 40, 42, and 44 beneath material filling opening 48, which allows the material from container 12 to refill volume chambers 40, 42, and 44, thereby enabling another volumetric cup of the material to be dispensed.

In one embodiment, volume chamber 40 has a volume of about one-quarter (¼) of a cup, volume chamber 42 has a volume of about one-twelfth ( 1/12) of a cup, and volume chamber 44 has a volume of about two-thirds (⅔) of a cup. This allows about one cup to be dispensed when volume chambers 40, 42, and 44 are extended out of slide stabilizing channel 50. Additionally, this combination allows smaller increments, such as about one-quarter (¼) of a cup, about one-half (½) of a cup, about three-fourths (¾) of a cup, about one-third (⅓) of a cup, and about two-thirds (⅔) of a cup of the materials to be selectively dispensed.

In the shown embodiment, volume chamber 42 has shorter lateral dimensions relative to volume chambers 40 and 44. If volume chamber 42 were otherwise as long laterally as volume chambers 40 and 44, volume chamber 42 would require thin longitudinal dimensions, which may restrict the material from entering volume chamber 42.

Accordingly, system 10 may dispense a full volumetric cup of material at one time. Additionally, system 10 may also dispense smaller increments of the materials with the use of option switches 26 and 28, which may function in the same manner as rear stoppers 24 when actuated. For example, when dispensing volumes in increments of the volume of volume chamber 40, such as increments of about one-quarter (¼) of a cup, a user may actuate option switch 26 by sliding option switch 26 until it extends past flat slide 54.

Using the same above-discussed dispensing steps, the user may pull handle 32 until option switch 26 contacts housing 14. This results in only volume chamber 40 being capable of extending out of slide containment channel 50 for dispensing material (e.g., for dispensing about one-quarter (¼) of a cup). This process may also be repeated for dispensing additional increments of the volume of volume chamber 40 (e.g., for dispensing about one-half (½) of a cup, about three-fourths (¾) of a cup, and the like).

Alternatively, when dispensing volumes in increments of the combined volumes of volume chambers 40 and 42 (shown in FIG. 2), the user may actuate option switch 28 by sliding option switch 28 until it extends past flat slide 54. In this example, option switch 26 is desirably in its retracted state. Accordingly, using the same above-discussed dispensing steps, the user may pull handle 32 until option switch 28 contacts housing 14. This results in only the combined volumes of volume chambers 40 and 42 being capable of extending out of slide containment channel 50 for dispensing material (e.g., for dispensing about one-third (⅓) of a cup). This process may also be repeated for dispensing additional increments of the combined volumes of volume chambers 40 and 42 (e.g., for dispensing about two-thirds (⅔) of a cup, and the like).

Accordingly, the locations of option switches 26 and 28 relative to rear stoppers 24 are desirably about the same as the relative locations of volume chambers 40, 42, and 44, thereby allowing volume chambers 40 and 42 to be selected independently from each other and from volume chamber 44. This arrangement allows system 10 to be used to dispense a variety of volumetric combinations. The above-discussed volumes for volume chambers 40, 42, and 44 are examples of suitable volumes that system 10 may be configured to dispense. However, in alternative embodiments, volume chambers 40, 42, and 44 may include different volumes from those discussed above.

Furthermore, in additional alternative embodiments, divided compartment 38 may include additional numbers of volume chambers, as particular dispensing needs may dictate. Examples of suitable numbers of volume chambers for use with system 10 range from two to ten, with particularly suitable numbers ranging from three to five.

In some embodiments, rear stoppers 24 and/or front stoppers 30 may be removable and/or derived from one or more flexible materials, thereby allowing hinged slide mechanism 16 to be removed from housing 14 (e.g., for cleaning purposes). Additionally, as discussed above, hinged slide mechanism 16 includes hinge 22, which enables hinged slide mechanism 16 to be folded against a storage container 12 and housing 14 when system 10 is not in use (e.g., as shown in FIG. 1). As discussed above, the use of housing 14 and hinged slide mechanism 16 allows predetermined volumes of materials to be readily dispensed, and sealed in a storage container 12 when not in use. Furthermore, in some embodiments, hinged slide mechanism 16 may be moved in the directions of arrows 36 and 28 (shown in FIG. 2) under motorized power. For example, hinged slide mechanism 16 may be operated with a computer-controlled motor, which may direct the movement of hinged slide mechanism 16 through slide containment channel 50 of housing 14.

Although the present disclosure has been described with respect to several embodiments, workers skilled in the art will recognize that changes may be made in form and detail without departing from the spirit and scope of the disclosure.

1. A dispensing system comprising:
a housing configured to engage with a storage container, the housing comprising:
an inlet opening configured to receive particulate materials from the storage container; and
a channel extending through the housing and having opposing openings, the channel being accessible to the inlet opening at a location between the opposing ends; and
a slide mechanism configured to extend through the channel, the slide mechanism comprising:
a first end configured to extend out of a first opening of the channel;
a second end that is an opposing end from the first end, the second end having at least one stop component, and being configured to extend out of the second opening of the channel; and
a plurality of volume chambers extending through the slide mechanism between the first end and the second end, and configured to be at least partially accessible to the inlet opening of the housing.

2. The dispensing system of claim 1, wherein the slide mechanism further comprises a hinge disposed between the second end and the plurality of volume chambers.

3. The dispensing system of claim 1, wherein the slide mechanism further comprises at least one option switch configured to restrict movement of the slide mechanism through the channel.

4. The dispensing system of claim 3, wherein the at least one option switch comprises a first option switch and a second option switch.

5. The dispensing system of claim 3, wherein the dispensing system is configured to dispense the material in increments of about one-quarter of a cup when the first option switch is actuated and is further configured to dispense the material in increments of about one-third of a cup when the second option switch is actuated.

6. The dispensing system of claim 1, wherein the plurality of volume chambers comprise:
a first volume chamber having a volume of about one-quarter of a cup;
a second volume chamber having a volume of about one-twelfth of a cup; and
a third volume having a volume of about two-thirds of a cup.

7. A dispensing system comprising:
a housing comprising:
an inlet opening configured to engage with a storage container; and
a channel extending through the housing and having opposing openings, the channel being accessible to the inlet opening at a location between the opposing ends; and
a slide mechanism comprising:
a first end configured to extend out of a first opening of the channel and further configured to hingedly fold;
at least on stop component configured to extend out of a second opening of the channel and further configured to restrict a range of motion of the slide mechanism within the channel;
a plurality of volume chambers extending through the slide mechanism between the first end and the at least one stop component, and configured to be at least partially accessible to the inlet opening of the housing; and
an option switch configured to further restrict the range of motion of the slide mechanism within the channel when the option switch is actuated.

8. The dispensing system of claim 7, wherein the dispensing system is configured to dispense the material in increments of about one cup when the option switch is not actuated.

9. The dispensing system of claim 7, wherein the dispensing system is configured to dispense the material in increments of about one-quarter of a cup when the option switch is actuated.

10. The dispensing system of claim 7, wherein the one option switch is a first option switch, and wherein the slide mechanism further comprises a second option switch.

11. The dispensing system of claim 10, wherein the dispensing system is configured to dispense the material in increments of about one-quarter of a cup when the first option switch is actuated and is further configured to dispense the material in increments of about one-third of a cup when the second option switch is actuated.

12. The dispensing system of claim 7, wherein the plurality of volume chambers comprise:
a first volume chamber having a volume of about one-quarter of a cup;
a second volume chamber having a volume of about one-twelfth of a cup; and
a third volume having a volume of about two-thirds of a cup.

13. The dispensing system of claim 7, wherein the housing and the slide mechanism are each fabricated from at least one material selected from the group consisting of thermoplastic materials, metallic materials, and combinations thereof.

14. A method of operating a dispensing system, the method comprising:
at least partially filling a plurality of volume chambers of a slide mechanism of the dispensing system with a material from a storage container engaged with a housing of the dispensing system, wherein each of the plurality of volume chambers has a different volume;
actuating an option switch of the slide mechanism;
moving the slide mechanism through a channel of the housing such that at least one of the volume chambers exits the channel;
restricting the movement of the slide mechanism through the channel to a range defined in part by the actuated option switch; and
dispensing the material from the at least one volume chamber that exited the channel.

15. The method of claim 14, and further comprising hingedly pivoting a first portion of the slide mechanism relative to a second portion of the slide mechanism.

16. The method of claim 14, wherein the option switch is a first option switch, and wherein the method further comprises actuating a second option switch configured to even further restrict movement of the slide mechanism through the channel.

17. The method of claim 16, wherein the dispensing system is configured to dispense the material in increments of about one-quarter of a cup when the first option switch is actuated and is further configured to dispense the material in increments of about one-third of a cup when the second option switch is actuated.

18. The method of claim 14, wherein the plurality of volume chambers comprise:
a first volume chamber having a volume of about one-quarter of a cup;
a second volume chamber having a volume of about one-twelfth of a cup; and
a third volume having a volume of about two-thirds of a cup.

19. The method of claim 14, and further comprising moving the slide mechanism through the channel of the housing such that at least one of the volume chambers enters the channel.

20. The method of claim 14, and further comprising:
re-actuating the option switch such that the option switch does not restrict the movement of the slide mechanism through the channel;
moving the slide mechanism through the channel of the housing such that at least one of the volume chambers exits the channel after re-actuating the option switch; and
dispensing the material from the at least one volume chamber that exited the channel after re-actuating the option switch.
